(19) United States
(12) Patent Application Publication
(10) Pub. No.: US 2026/0196133 A1
(43) Pub. Date: Jul. 9, 2026

(54) CONTINUOUS REAL TIME DRIVING FROM AIR

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/037,306

(22) Filed: Jan. 27, 2025

Related U.S. Application Data
(60) Provisional application No. 63/741,926, filed on Jan. 5, 2025.

(51) Int. Cl. G08G 1/0967

(52) U.S. Cl. CPC G08G 1/096791; G08G 1/096725

(57) ABSTRACT

A method for continuous real time driving from air, the method includes obtaining, during inference by a computerized system associated with an aerial system, aerial information captured by the aerial system at a period of time and a location corresponding to a driving of one or more different ground vehicles, wherein the aerial system is associated with computerized systems of the one or more different ground vehicles; processing, in real-time by artificial intelligence models of the computerized system, the aerial information with respect to a specified ground vehicle of the one or more different ground vehicles, to provide a driving related decision for the specified ground vehicle for autonomous driving; and communicating, in real-time, the driving related decision to a computerized system associated with the specified ground vehicle.

### CROSS REFERENCE

This application claims priority from U.S. provisional patent filing date Jan. 5, 2025, Ser. No. 63/741,926 which is incorporated herein by reference.

### BACKGROUND

Autonomous ground vehicle (referred to as ground vehicle s) such as autonomous taxies (also referred to as robotaxi) have a limited field of view, which impacts their decision making.

Additionally or alternatively, the ground vehicles may have limited computational resources (and/or harsher power consumption limitations) in comparison to stronger computerized systems (such as cloud computing environment computerized system)—which may impact the decisions made in relation to autonomous driving.

Additionally or alternatively, the ground vehicles may experience temporary failures in relation to decisions made in relation to autonomous driving.

There is a need to provide an autonomous driving related solution that is more accurate and/or more robust and/or more powerful in comparison to solution that is solely based on the ground vehicle.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a vehicle;

FIG. 3 illustrates an example of field of view of an aerial system and a field of a view of a ground vehicle;

FIG. 4 illustrates an example of an aerial computerized system, a field of view of an aerial system and a field of a view of a ground vehicle;

FIG. 5 illustrates an example of computerized systems, a field of view of an aerial system and a field of a view of a ground vehicle;

FIG. 6 illustrates an example of a communication between the aerial system and a ground vehicle, a field of view of an aerial system and a field of a view of a ground vehicle;

FIG. 7 illustrates an example of one or more computerized systems, one or more networks, and fields of view of aerial systems;

FIG. 8 illustrates an example of a method of continuous real time driving from air;

FIGS. 9 and 10 illustrate examples of the method of FIG. 8; and FIG. 11 illustrates an example of a method of continuous real time driving from air.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment, there is provided a computerized system, including for example at least one processing device, that is of, or associated with a ground vehicle copilot and configured to assist in autonomous driving of different ground vehicles based on aerial information.

According to an embodiment, the aerial information has a larger coverage than the field of view of the ground vehicle. The larger coverage allows to be aware of more events and/or other relevant information at the future path of the ground vehicle—thereby allowing to provide a decision that is based on more relevant information—and thus is more accurate.

According to an embodiment, the aerial information is processed by one or more computerized systems (of the ground vehicle copilot), at least some of which is are associated with the aerial system that acquired the aerial information—and the one or more computerizes systems are stronger than the computerized system of the ground vehicle. According to an embodiment, the association includes communication between the aerial system and the one or more computerized systems.

According to an embodiment, the aerial information is processed by one or more computerized systems (of a ground vehicle copilot) that may consume more power (for example by a factors of at least 2-10) than the computerized system of the ground vehicle-and thus can apply more complex and accurate processes in relation to the computerized system of the vehicle.

According to an embodiment, the decisions provided by the ground vehicle copilot provide redundancy—in case of a failure of a ground vehicle decision making.

According to an embodiment, the driving related decisions provided by the ground vehicle copilot provide redundancy are used to perform driving related decision making in addition to driving related decisions generated by the ground vehicle based on information sensed by the ground vehicle.

According to an embodiment, the driving related decisions provided by the ground vehicle copilot and/or the aerial information are provided to a computerized system that facilitates human supervision and/or feedback—so that human feedback and/or human driving related decisions may be generated and sent to the ground vehicle. An example of such a computerized system is a teleoperation system.

According to an embodiment, the ground vehicle copilot receives aerial information from one or more aerial units having one more corresponding fields of views. Different fields of views may at least partially overlap or may not overlap.

According to an embodiment, an aerial system that acquired the aerial information at least partially processes the aerial information to provide at least partially processed aerial information and/or driving related decisions.

According to an embodiment, the processing of the aerial information includes multiple processing operations such as but not limited to location determination of ground vehicles, detection of objects, lane detection, determining kinematics of the ground vehicles and/or other objects, path planning, and the like. A partially processed aerial information may include the outcome (or an intermediate product) of one or more of these processing operations (or any other processing operation required for generating the driving related decision)—for example bounding boxes related to detected objects, kinematics (speed, acceleration, direction of progress) of any object, lane preserving decisions, location of a ground vehicle within a lane, hazard indication, suggested propagation of a ground vehicle, and the like.

Any reference to a communication of a driving related decision should be applied mutatis mutandis to the communication of aerial information and/or should be applied mutatis mutandis to the communication of partially processed aerial information and/or should be applied mutatis mutandis to a driving related information.

The driving related information may be aerial information, a representation of aerial information, or at least partially processed aerial information that does not amount to a driving related decision.

According to an embodiment, the aerial information and/or the driving related decision and/or the at least partially processed aerial information are provided to the ground vehicle in a partial, or differential manner—(delta)—that include the difference between (i) a new aerial information and/or the driving related decision and/or the at least partially processed aerial information, and (ii) already existing (at the ground vehicle) corresponding aerial information and/or the driving related decision and/or the at least partially processed aerial information.

The driving related decision is analyzed to include communication of partial information, based on the processing of the aerial information, to include only new, or updated driving related information in comparison to existing object lists and object list information at the ground vehicle.

Any reference to a driving related decision should be applied mutated mutandis to partially processed aerial information and/or should be applied mutatis mutandis, to processed aerial information, and/or to a driving related information.

According to an embodiment, the at least processed aerial information includes a driving related decision.

According to an embodiment, the aerial system communicates the aerial information and the at least partially processes information and/or driving related decisions.

According to an embodiment, the aerial system communicates the at least partially processed information and/or driving related decisions and not the aerial information.

According to an embodiment, the aerial system determined whether to at least partially process the aerial information and/or the amount of processing (full processing or the amount of partially processing) based on one or more parameters such as the communication conditions (for example available bandwidth for transmission, signal to noise ratio of transmitted signal, distance to communication systems that are supposed to receive the information) and/or memory constraints (amount of available memory resources required for processing), and/or processing constraints (amount of available processing resources required for processing), and/or power constraints (for example battery status—as an emptier battery may result in allocating less resources for processing—or the relationship between the battery and the time to complete a current aerial sensing task), and the like.

According to an embodiment, the aerial system is regarded as a part of the ground vehicle copilot—especially when the aerial system at least partially processed the aerial information.

According to an embodiment, the ground vehicle copilot augments the aerial information with additional information that is not sensed by the aerial system. For example—the aerial information may not accurately capture traffic signs and/or traffic lights (or may senses the presence of such elements but not their content—such as the content of a traffic sign or which light is on).

According to an embodiment the additional information may be sensed by one or more other sensors (the ground vehicle sensors, sensors of other ground vehicle, stationary sensors), and/or be provided by maps or other information sources such as traffic light operating schedules. It should be noted that usage of some of the additional information involves localizing the traffic sign and/or the traffic light.

According to an embodiment, elements such as traffic signs includes visual information that is faces the sky and is captured by the aerial system.

According to an embodiment, the ground vehicle copilot sees in real-time what the ground vehicle—and also far beyond the ground vehicle (as it exhibits an extended perception), applied a more robust environmental model related to the aerial information, and is configured to makes driving related decisions based on the ability to predict and see more (for example coverage that exceeds the field of view of the ground by a factors of at least 1.5 to 50) than the ground vehicle.

According to an embodiment, the processing of the aerial information includes at least one out of determining location of ground vehicle captured by the aerial information, perception related processing such as object detection, lane detection, kinematics of objects, path planning, driving related decision making and the like.

According to an embodiment, the ground vehicle copilot is configured to detect road players in a much longer distance than other ground sensors (for example one kilometer or more versus tens of meters till two hundred fifty meters when not obscured—by a ground vehicle sensor).

According to an embodiment, the ground vehicle copilot analyzes, in real-time analyzes the aerial information, the view from air is translated to a related view from one or more ground vehicles and provides the relevant information to the one or more ground vehicle, in relation to it.

According to an embodiment, the processing of the aerial information includes determining the one or more locations of the one or more ground vehicles and/or the locations of one or more road players and/or the locations or one or more lanes.

According to an embodiment, the ground vehicle copilot is configured to provide an enhanced perception—for example by fusing the aerial information and ground vehicle sensed information—and may provide an improved accuracy of object detection and lane detection and/or an improved accuracy of kinematics (distance, velocity).

According to an embodiment, a ground vehicle (once fed with aerial information and/or at least partially processed information and/or decisions from the ground vehicle copilot) is configured to provide an enhanced perception—for example by fusing the aerial information and ground vehicle sensed information—and may provide an improved accuracy of object detection and lane detection and/or an improved accuracy of kinematics (distance, velocity).

According to an embodiment, the processing of the aerial information is executed in a distributed manner and/or in a collaborative manner by multiple computerized systems.

According to an embodiment, the multiple computerized systems include an aerial computerized system or do not include the aerial computerized system.

According to an embodiment, the multiple computerized systems include a ground vehicle computerized system or do not include the ground vehicle computerized system.

According to an embodiment, the multiple computerized systems includes a computerized system that does not belong to the aerial system or to the ground vehicle—for example, a computerized system within a cloud computerized environment.

According to an embodiment, the ground vehicle copilot provides redundancy—and acts as a backup system to ensure continued functionality and safety in the event of a primary system failure, examples:
sensor redundancy—if a camera of the ground vehicle is obscured, the ground vehicle copilot provides sufficient data for safe operation of the ground vehicle.
redundant localization—if Global Positioning System signals are lost in an urban environment and/or tunnel or urban canyon, the ground vehicle copilot provides location information that keeps the ground vehicle on track.
redundant decision making—if the ground vehicle software encounters an unexpected error, the ground vehicle copilot takes over to ensure safe autonomous driving and/or maneuvers, for example avoiding collision or bringing the vehicle to a safe stop.
redundant path planning—if a vision based path planner of the ground vehicle failed, the ground vehicle copilot continues operating to ensure safe navigation of the ground vehicle.

According to an embodiment the ground vehicle copilot is in communication with human feedback and/or control services such as teleoperation services—provide additional insights and alerts in real-time to human operators, will increase efficiency and enhance driving safety.

The term real-time refers to within less than a second, within 1-3 or 1-5 or 2-10 seconds, and the like.

According to an embodiment, the ground vehicle copilot is configured to operate in an emergency mode when receiving a distress indication from the ground vehicle and/or when the ground vehicle is about to lose communication and/or when a GPS error associated with the region in which the ground vehicle is located and/or when being notified that a sensor of the ground vehicle malfunctions and/or when the services of the ground vehicle are expected to be required-and responds more quickly than usual.

According to an embodiment, the one or more aerial systems cover different regions during different points of time.

According to an embodiment a coverage scheme of the one or more aerial systems is determined by the ground vehicle copilot, is determined by another entity regardless of inputs from the ground vehicle copilot, is determined by another entity based at least in part to inputs provided by the ground vehicle copilot, is determined by another entity regardless of inputs from the ground vehicle, is determined by another entity based at least in part to inputs provided by the ground vehicle, and the like. For example—the coverage scheme is determined based on feedback or instructions provided by a computerized system that facilitates human supervision and/or feedback.

According to an embodiment the coverage scheme is based on at least one of location, time, on-demand requests, traffic density, events, detected hazards, weather conditions, and the like.
For example—apply a zone based coverage scheme.
For example—there are no-flight zones and/or places such as airports, naval ports, military bases, power plants, which cannot be covered by the aerial system—especially a low altitude aerial system.
Places with sparse density of vehicles—may be allocated with less aerial systems, and/or allocate coverage by aerial system at a lower frequency, e.g., once a day, or only during relative rush hours.
Being time sensitive—for example daylight operation vs. night operation e.g., allocated more drones/in higher frequency in peak hours e.g., every hour or 30 minutes
For example apply a coverage scheme that is on demand and/or event sensitive.
For example apply a coverage scheme that is sensitive to known or expected road hazards and/or risks—for example to risks identifies by one or more vehicles.
For example apply a coverage scheme that is sensitive to terrain conditions—different types of aerial systems (for example different types of UAVs) to different terrain conditions—for example using zeppelin balloons for mountains.
For example using an array of drones with predefined or dynamic routes.
For example using one or more drones that follow one or more ground vehicles.

According to an embodiment a processing (full or partially processing) related to aerial information and (for example) the generation of the driving related decision is executed by any known method and/or by any known one, or more components or process of a driving assistance system or an autonomous driving system, including an object detection unit, a decision making unit for driving, a control unit for driving, a prediction unit for driving, a localization unit or process for driving, among others.

According to an embodiment the processing includes using an ensemble or narrow Artificial Intelligence agents—one or more examples are illustrated in any one of following applications—all being incorporated herein by reference—U.S. patent application Ser. No. 17/817,928 filing date Aug. 5, 2022; U.S. patent application Ser. No. 17/817,935 filing date Aug. 5, 2022; U.S. patent application Ser. No. 18/036,150 filing date Apr. 15, 2021; U.S. patent application Ser. No. 18/459,416 filing date Aug. 13, 2023.

According to an embodiment, the processing includes calculating perception and/or virtual fields—one or more examples are illustrated in any one of following applications—all being incorporated herein by reference—U.S. patent application Ser. No. 18/350,714 filing date Jul. 11, 2023; U.S. patent application Ser. No. 18/350,684 filing date Jul. 11, 2023.

According to an embodiment, the processing includes perception processing that includes generating cropped images that correspond to the locations of items, generating signatures or embeddings or signatures of embeddings and determining, based on reference metadata detecting items such as objects.

According to an embodiment, the processing includes calculating signatures and/or embeddings—one or more examples are illustrated in any one of following applications—all being incorporated herein by reference—U.S. patent application Ser. No. 16/729,589 filing date Dec. 20, 2019, PCT patent application PCT/IB2019/058207 filing date Sep. 27, 2019.

According to an embodiment, the processing includes applying at least one of rule based processing, artificial intelligence based processing, neural network processing, object tracking, filtering (for example using a Kalman filter), and the like.

According to an embodiment the processing include using one or more artificial intelligent agents or module that were trained according to the method illustrated in U.S. provisional patent Ser. No. 63/741,926 filing date Jan. 5, 2025, which is incorporated herein by reference.

According to an embodiment, the processing includes at least one of the following

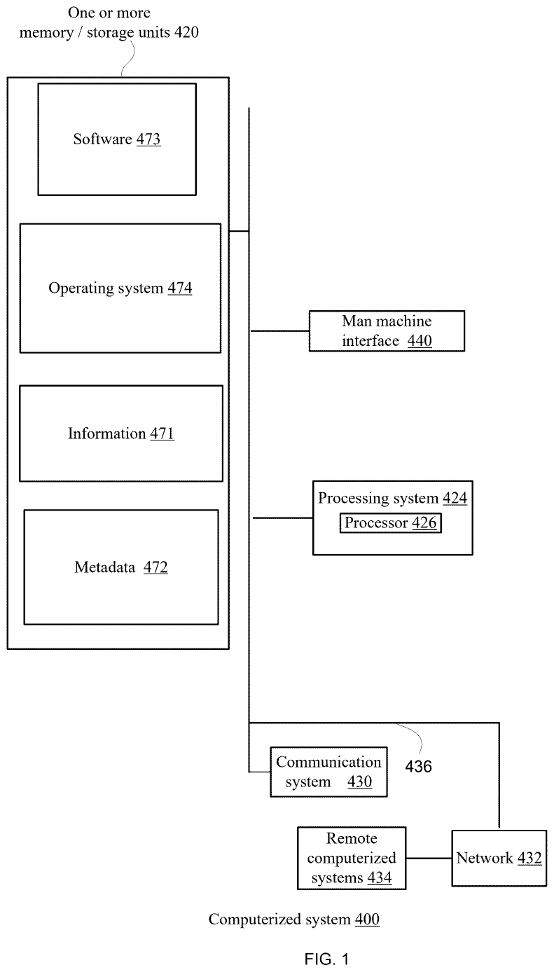

FIG. 1 illustrates an example of a computerized system 400.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop, or any other computer and may include or be in communication with a sensing unit and/or a controller.

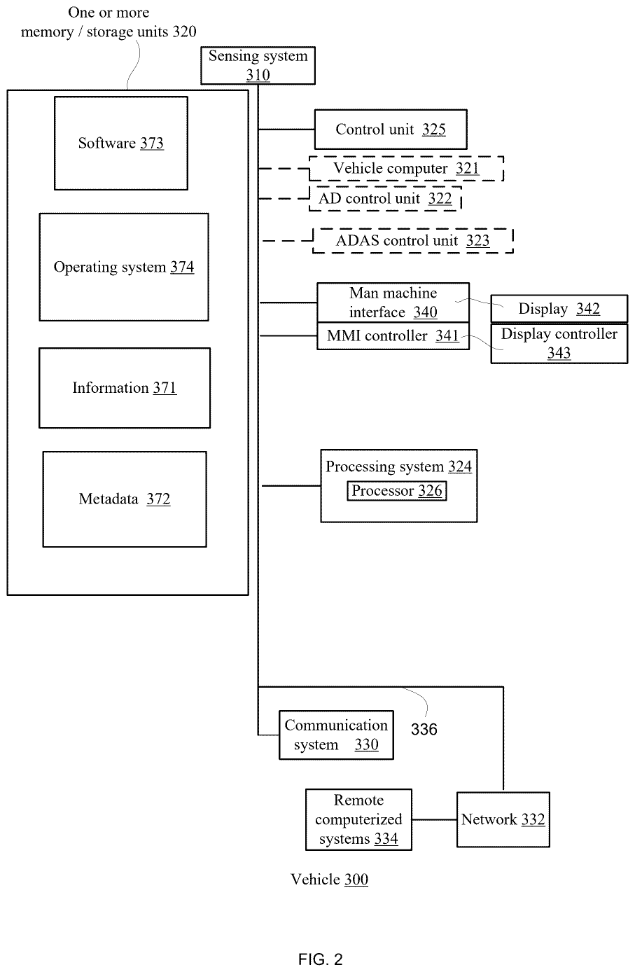

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example-any reference to processor should be applied mutatis mutandis to multiple processors, any reference to communication system 430 should be applied mutatis mutandis to multiple communication systems.

According to an embodiment, the memory and/or storage units 420 stores at least one of: operating system 474, information 471, metadata 472, and software 473.

According to an embodiment, processing system 424 is configured to perform any method illustrated in the application while executing software.

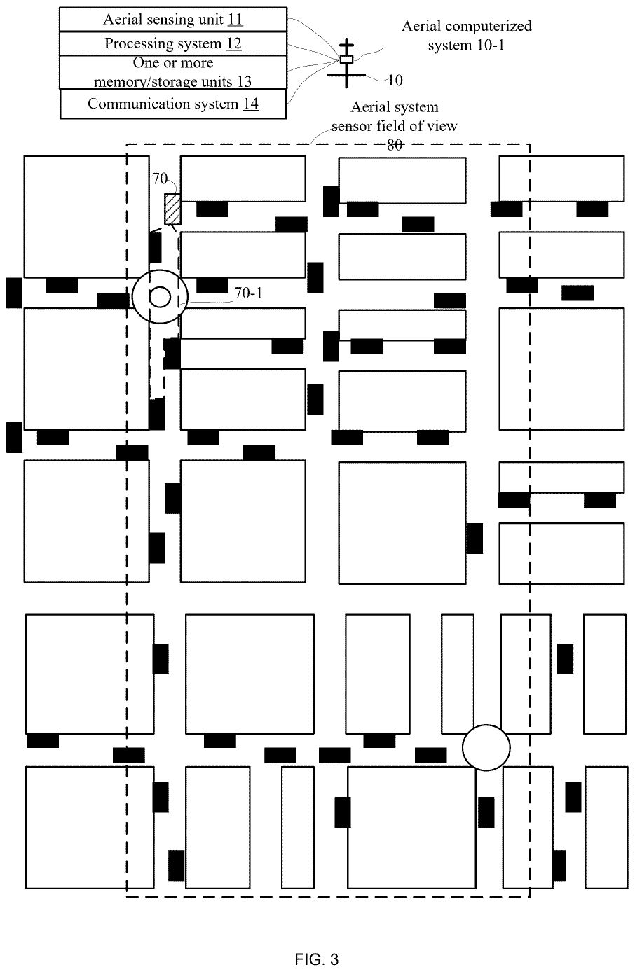

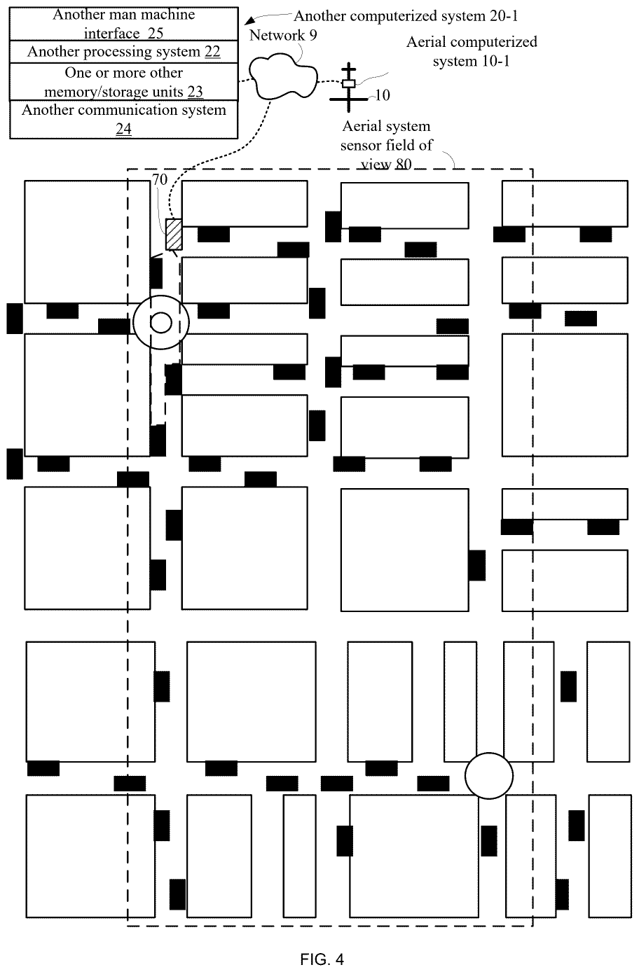

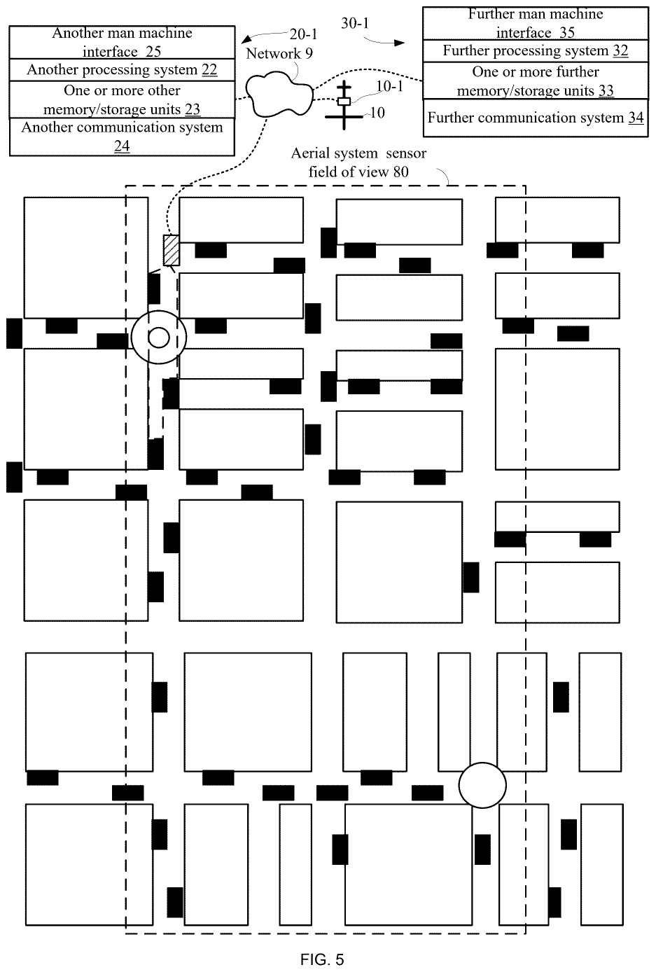

According to an embodiment, an instance of or a version (having one or more different entities or one or more less entities) of the computerized system 400 is included in the aerial system (see for example aerial computerized system 10-1 of FIGS. 3-6, and/or aerial computerized systems 91-1, 92-1, 93-1, 94-1 of FIG. 7) and/or is included in other entities (see for example one or more computerized systems 88 of FIG. 7, computerized systems 20-1 and 30-1 of FIG. 5, computerized system 20-1 of FIG. 4).

Any reference to computerized system 400 should be applied mutatis mutandis to any computerized system illustrated in the specification.

FIG. 2 illustrates an example of vehicle 300 configured to utilize the set of artificial intelligence models during inference.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop, or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks-at least some of which are not currently stored in the vehicle.

According to an embodiment, the memory and/or storage unit 320 stores at least one of: operating system 374, information 371, metadata 372, and software 373.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the ground vehicle.

The vehicle computer 321 is configured to control the operation of the vehicle—especially controlling the engine, the transmission, and any other vehicle system or component.

The vehicle computer 321 may be in communication with an engine control module, a transmission control module, a powertrain control module, and the like.

FIG. 3 illustrates an example of field of view 80 of an aerial system 10 and a field of a view 70-1 of a ground vehicle 7. The field of view 80 of the aerial system 10 well exceeds the field of view 70-1 of the ground vehicle 70 and provide much more information to be processed in order to provide a driving related decision. For example—field of view 10 covers multiple road segments, a roundabout and other ground vehicle that are located at one or more possible future paths of ground vehicle 70 and/or within a defined path of the vehicle.

FIG. 3 also illustrates the aerial computerized system 10-1 as including aerial sensing unit 11 (not included in computerized system 400 of FIG. 1), processing system 12, one or more memory/storage units 13 and communication system 14. Any reference to sensing unit 310 of FIG. 2 should be applied mutatis mutandis to aerial sensing unit 11 (especially the larger coverage, using aerial sensors that differ from the ground vehicle sensors). Any reference to processing system 12, one or more memory/storage units 13 and communication system 14 should be applied mutatis mutandis to processing system 424 of FIG. 1, one or more memory/storage units 420 of FIG. 1 and communication system 430 of FIG. 1, respectively.

It should be noted that the aerial computerized system may also include an aerial man machine interface (not shown).

FIG. 4 differs from FIG. 3 by further illustrating:
Another computerized system 20-1 that does not belong to the aerial system or to the ground vehicle.
A network 9 used for communication between the aerial computerized system 10-1, the other computerized system 20-1, and ground vehicle 70.

The other computerized system 20-1 includes another man machine interface 25, another processing system 22, one or more other memory/storage units 23 and another communication system 24. Any reference to another man machine interface 25, another processing system 22, one or more other memory/storage units 23 and another communication system 24 should be applied mutatis mutandis to man machine interface 440 of FIG. 1, to processing system 424 of FIG. 1, to one or more memory/storage units 420 of FIG. 1 and communication system 430 of FIG. 1, respectively.

It should be noted that the aerial system may communicate with one or multiple ground vehicles and/or one or more computerized system to support the ground vehicle copilot functionality.

FIG. 5 differs from FIG. 4 by further illustrating further computerized system 30-1 that does not belong to the aerial system or to the ground vehicle.

Network 9 used for communication between the aerial computerized system 10-1, further computerized system 30-1, and ground vehicle 70.

The further computerized system 30-1 includes further man machine interface 35, further processing system 32, one or more further memory/storage units 33 and further communication system 34. Any reference to further man machine interface 35, further processing system 32, one or more further memory/storage units 33 and further communication system 34 should be applied mutatis mutandis to man machine interface 440 of FIG. 1, to processing system 424 of FIG. 1, to one or more memory/storage units 420 of FIG. 1 and communication system 430 of FIG. 1, respectively.

It should be noted that one of more of the computerized systems (for example computerized system 20-1 and/or 30-1) may facilitate human supervision and/or feedback-so that human feedback and/or huma decisions may be generated and sent to the ground vehicle. An example of such a computerized system is a teleoperation system.

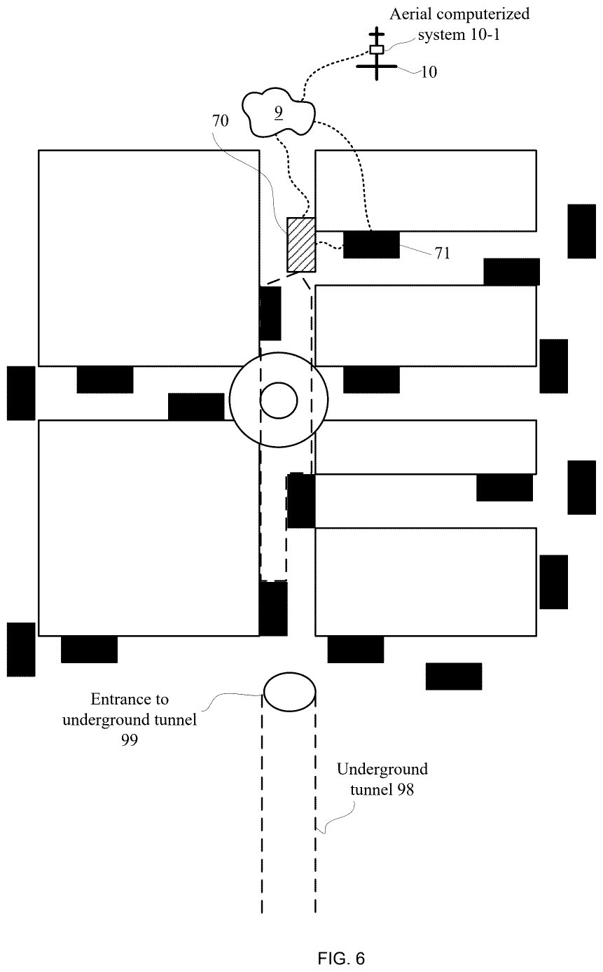

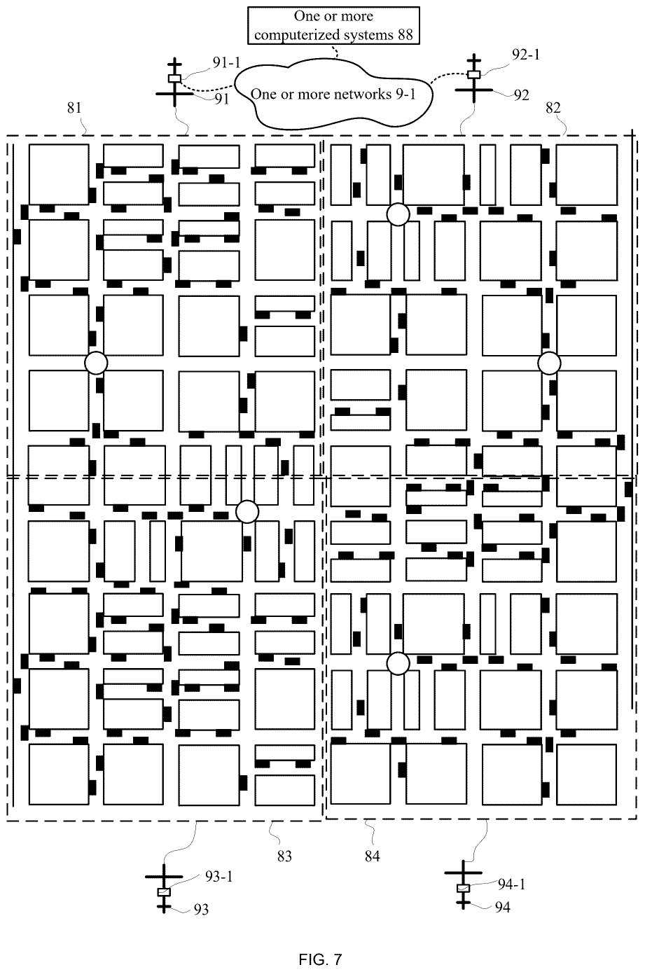

FIG. 6 illustrates an example of a communication between the aerial computerized system 10-1 and ground vehicle 70, an underground tunnel 98 and an entrance 99 to the underground tunnel that is not seen by the ground vehicle but is seed by the aerial system. The aerial system may send an alert regarding the underground tunnel 98 as well as location information and/or other information (such as driving decision to be executed during the driving in the underground tunnel) to the vehicle before the vehicle enters the underground tunnel.

FIG. 6 also illustrates a communication between the aerial computerized system 10-1, ground vehicle 70 and another ground vehicle 71. The vehicle may communicate via vehicle to vehicle communication, via network or without using network 9.

FIG. 7 illustrates an example of one or more computerized systems 88, one or more networks 9-1, aerial systems 91, 92, 93 and 94 having aerial computerized systems 91-1, 91-2, 91-3 and 91-4 respectively and fields of views 81, 82, 83 and 94, respectively.

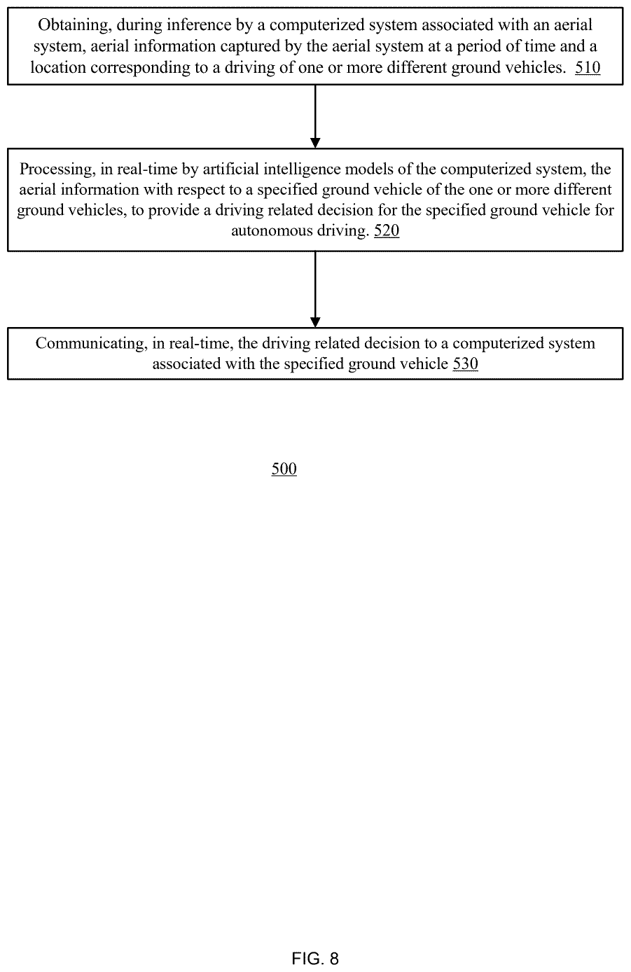

FIG. 8 illustrates an example of method 500 for continuous real time driving from air.

According to an embodiment, method 500 includes step 510 of obtaining, during inference by a computerized system associated with an aerial system, aerial information captured by the aerial system at a period of time and a location corresponding to a driving of one or more different ground vehicles, wherein the aerial system is associated with computerized systems of the one or more different ground vehicles.

According to an embodiment, step 510 uses aerial information that captures the one or more different ground vehicles—which requires that these one or more different ground vehicles be within the field of view of the aerial system to be captured by the aerial system.

According to an embodiment the aerial system is associated with computerized systems that do not belong to the one or more different ground vehicles.

According to an embodiment, step 510 is followed by step 520 of processing, in real-time by artificial intelligence models of the computerized system, the aerial information with respect to a specified ground vehicle of the one or more different ground vehicles, to provide a driving related decision for the specified ground vehicle for autonomous driving.

According to an embodiment, the processing occurs during inference, in real time, at a computerized system, or in at least one processing device, in the cloud.

According to an embodiment, the processing occurs in real time at a computerized system, or in at least one processing device, of the aerial system.

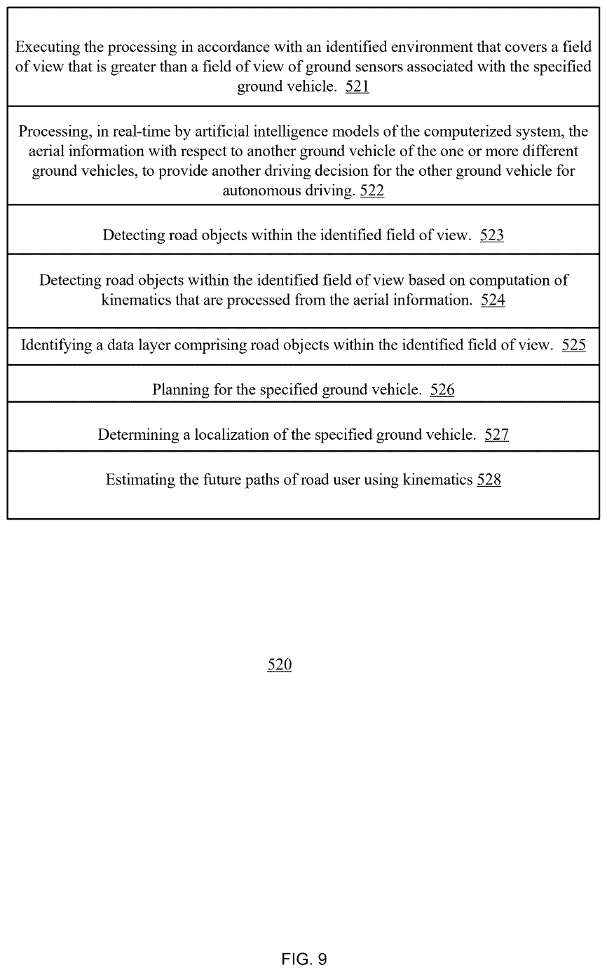

According to an embodiment, step 520 includes at least one of (see FIG. 9):
Step 521 of executing the processing in accordance with an identified environment that covers a field of view that is greater than a field of view of ground sensors associated with the specified ground vehicle.
Step 522 of processing, in real-time by artificial intelligence models of the computerized system, the aerial information with respect to another ground vehicle of the one or more different ground vehicles, to provide another driving decision for the other ground vehicle for autonomous driving.
Step 523 of detecting road objects within the identified field of view.
Step 524 of detection road objects within the identified field of view based on computation of kinematics that are processed from the aerial information.
Step 525 of identifying a data layer comprising road objects within the identified field of view.
Step 526 of path planning for the specified ground vehicle.
Step 527 of determining a localization of the specified ground vehicle.
Step 528 of estimating the future paths of road user using kinematics.

According to an embodiment, step 520 is followed by step 530 of communicating, in real-time, the driving related decision to a computerized system associated with the specified ground vehicle.

Accordingly in an implementation, the driving related decision outputs driving related information, such as kinematics pertaining to road objects on the ground in relation to the specified ground objects, determined localization information pertaining to and indicative of the real-time location of the ground vehicle, identified data layer holding data of a particular type of road objects, e.g. data lanes, road markings, pedestrians, cyclists, etc., in relation to the specified ground vehicle. In another implementation, the driving related decision outputs a control command for autonomous driving.

According to an embodiment, partially processed aerial information and/or raw aerial information is also communicated to the computerized system associated with the specified ground vehicle.

According to an embodiment, the aerial information is captured by the aerial system using an artificial intelligence model trained based on aerial information units for use in driving.

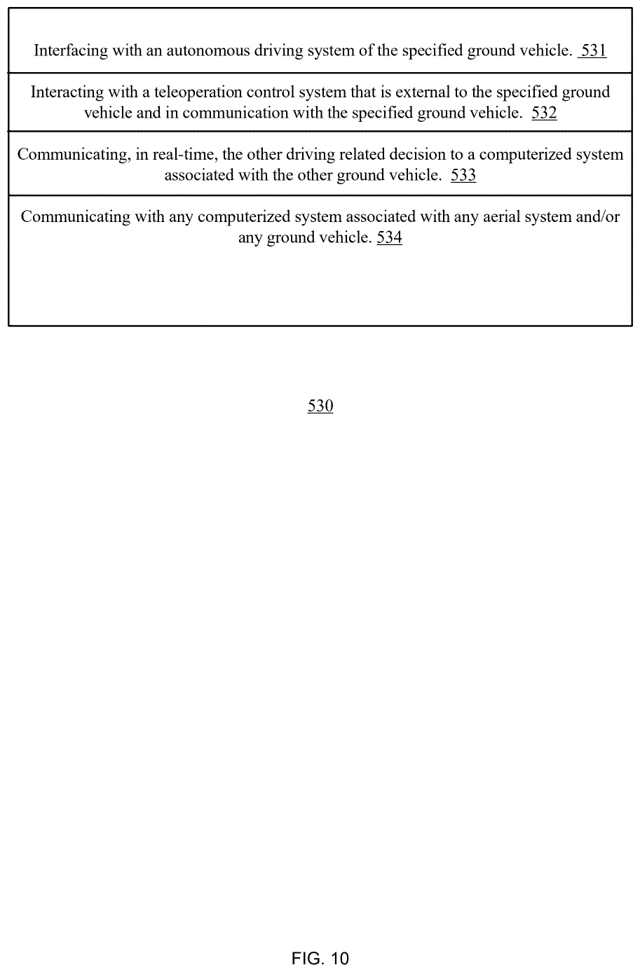

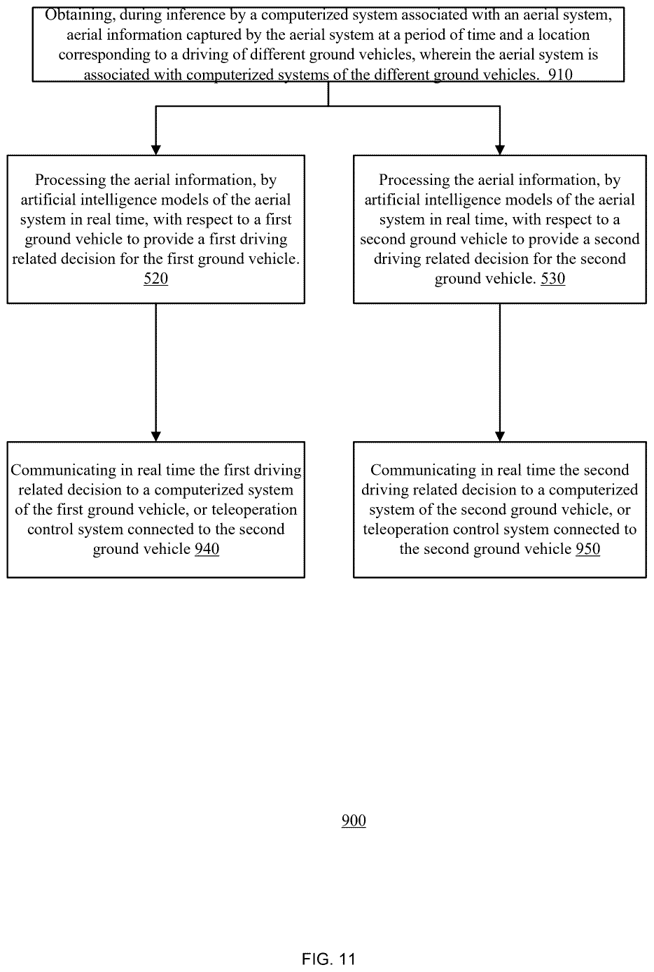

According to an embodiment, step 530 includes at least one of (see FIG. 10):
Step 531 of interfacing with an autonomous driving system of the specified ground vehicle.
Step 532 of interacting with a teleoperation control system that is external to the specified ground vehicle and in communication with the specified ground vehicle.
Step 533 of communicating, in real-time, the other driving related decision to a computerized system associated with the other ground vehicle.
Step 534 of communicating with any computerized system associated with any aerial system and/or any ground vehicle.

According to an embodiment the communicating is followed by verifying the execution of the driving related decision—for example by monitoring the specified ground vehicle, by communicating with ground vehicle, by processing aerial information, and the like.

According to an embodiment the verifying is followed by sending feedback to the specified ground vehicle.

According to an embodiment the communicating is followed by executing the driving related decision—for example by sending instructions to the specified ground vehicle, by taking over the control to the specified ground vehicle.

According to an embodiment the communicating is followed by receiving instructions or feedback originated by a human (for example—from a teleportation service) and sending the feedback or instructions to the specified ground vehicle—or taking over the control to the specified ground vehicle.

According to an embodiment, the aerial information is processed in relation to different specified ground vehicles—to provide driving related decisions to the different specified ground vehicle.

According to an embodiment, the same computerized system performs the processing in relation to the different specified ground vehicles.

According to an embodiment, two or more computerized systems perform the processing in relation to the different specified ground vehicles. The two or more computerized systems may collaborate with each other (for example assign different types of processing operations to different computerized systems), or they may allocate the different processing between them without overlap between the specified ground vehicles.

According to an embodiment, method 500 may be executed so that step 520 is repeated for different specified ground vehicles—or that step 520 performed the processing related to different specified ground vehicles in parallel or in batches.

FIG. 11 illustrates an example of method 900 of processing in relation to different specified ground vehicles. Method 900 includes:
Step 910 of obtaining, during inference by a computerized system associated with an aerial system, aerial information captured by the aerial system at a period of time and a location corresponding to a driving of different ground vehicles, wherein the aerial system is associated with computerized systems of the different ground vehicles. Step 910 is followed by steps 920 and 930.
Step 920 of processing the aerial information, by artificial intelligence models of the aerial system in real time, with respect to a first ground vehicle to provide a first driving related decision for the first ground vehicle. Step 920 is followed by step 940.
Step 930 of processing the aerial information, by artificial intelligence models of the aerial system in real time, with respect to a second ground vehicle to provide a second driving related decision for the second ground vehicle. Step 930 is followed by step 950.
Step 940 of communicating in real time the first driving related decision to a computerized system of the first ground vehicle, or teleoperation control system connected to the second ground vehicle.
Step 950 of communicating in real time the second driving related decision to a computerized system of the second ground vehicle, or teleoperation control system connected to the second ground vehicle.

The term obtaining include receiving and/or generating.

According to an embodiment, in a redundancy scenario, there is no need to perform the localization (e.g. using front camera, etc).

According to an embodiment, the aerial system associated with the ground vehicle copilot localizes the autonomous vehicle in real time and send an object list, or control commands, to the ground vehicle.

According to an embodiment, the aerial system associated with the ground vehicle copilot determines the localization of the ground vehicle, or the localization of road users with respect to the ground vehicle, as a part of a perception process. The localization of road users involves detecting the bounding boxes of road players and localizing them in space with respect to the ground vehicle.

According to an embodiment, the driving related decision is sent out in a differential manner—by communicating only partial information—delta. For example—the minimal amount of new, or different information) to the computerized system of the specified ground vehicle.

According to an embodiment—the partial information—the delta—includes information regarding one or more objects that does not appear in an existing object list of the ground vehicle.

According to an embodiment, the delta is based on analyzing an object list created from the aerial information in comparison to an object list obtained from the ground vehicle, or in comparison to an object list created based on prediction, etc.

In an embodiment, the analyzing is performed at the computerized system associated with the aerial system.

In an embodiment, the analyzing is performed by using artificial intelligence models trained for autonomous driving, by determining discrepancies between driving data and object information of objects lists of the ground vehicle and detected objects and object lists created by processing of the aerial information.

According to an embodiment, the delta data pertains to correction, or update of information (such as distance information) relating to existing road objects; or to new information relating to new road objects.

According to an embodiment, any processing (or at least partially processing) is executed by one or more computerized systems associated with the ground vehicle copilot—for example a computerized system within a cloud computing environment—and/or a computerized system of the aerial system.

According to an embodiment any driving related decision generated by any computerized system (either included in the ground vehicle copilot or not) may include or may be converted to (by a computerized system of the ground vehicle or by another computerized system) a request and/or a determining of an instruction and/or an instruct and/or a trigger and/or a control of and/or a performance of an autonomous driving related operation of the ground vehicle. The driving related decision may be related to a velocity and/or acceleration and/or direction of movement of the ground vehicle at one or more points in time. According to an embodiment, the driving related decision is aimed to one or more ground vehicle components such as brakes, clutch, engine, gear, or any other component that sets the velocity and/or acceleration and/or direction of movement of the ground vehicle.

According to an embodiment any driving related decision generated by any computerized system is in compliant with one or more levels of autonomous driving—such as L2, L2+, L2++, L3 or L4 autonomous driving.

Artificial intelligence is used in relation to machines that mimic human intelligence and human cognitive functions like learning and problem solving. There are three types of artificial intelligence that include artificial super intelligence, artificial narrow intelligence, and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

Any reference to information should be applied mutatis mutandis to one or more parts of the information. The information may be aerial information, training information, behavioral information, and/or other source, or type of information.

An aerial information unit (AIU) can pertain to one or more aerial images and/or one or more video segments, captured by aerial sensors of an aerial system, or aerial vehicle, and the like. According to an embodiment, one or more AIUs are acquired by one or more aerial sensors such as a satellite, a drone, manned airplanes, manned or an unmanned aerial vehicle, aerial military equipment, aerial commercial equipment, and others.

The AIU may be of any wavelength—for example, the aerial information unit may be a visual light AIU, a monochromatic AIU, a radar AIU, an infrared AIU, a thermal AIU, a near infrared AIU, and the like.

According to an embodiment, one or more AIUs capture driving behaviors of at least 10, 100, 200, 500, 1000, 2000 road users, such as vehicles, per minute.

According to an embodiment, one or more AIUs cover an area that ranges between 50 and 10,000,000 square meters.

According to an embodiment, one or more AIUs are acquired from heights that range between tens of meters and ten thousands of kilometers. For example—an AIU may be captured by geostationary satellites that are placed at an altitude of around 35786 kilometers.

According to an embodiment, the aerial information different AIUs are captured by different types of aerial sensors and the processing of the aerial information includes sensor fusion.

According to an embodiment a scenario incorporates multiple aspects of and metrics affecting implementation of a model for autonomous driving, including for example a location of the vehicle, one or more weather conditions, one or more contextual parameters, road condition, traffic parameter(s). Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A method for continuous real time driving, the method comprises:
obtaining, during inference by a computerized system associated with an aerial system, aerial information captured by the aerial system at a period of time and a location corresponding to a driving of one or more different ground vehicles, wherein the aerial system is associated with computerized systems of the one or more different ground vehicles;
processing, in real-time by artificial intelligence models of the computerized system, the aerial information with respect to a specified ground vehicle of the one or more different ground vehicles, to provide a driving related decision for the specified ground vehicle for autonomous driving; and
communicating, in real-time, the driving related decision to a computerized system associated with the specified ground vehicle, for continuous real time driving of the specified ground vehicle from air.

2. The method of claim 1, wherein the aerial information is captured by the aerial system using an artificial intelligence model trained based on aerial information units for use in driving.

3. The method of claim 1, wherein the processing of the aerial information is in accordance with an identified environment that covers a field of view that is greater than a field of view of ground sensors associated with the specified ground vehicle.

4. The method of claim 1, wherein the communicating involves interfacing with an autonomous driving system of the specified ground vehicle; and incorporating the driving related decision in an autonomous driving decision making of the specified ground vehicle.

5. The method of claim 1, wherein the communicating involves interacting with a teleoperation control system that is external to the specified ground vehicle and in communication with the specified ground vehicle.

6. The method of claim 1, further comprising:
processing, in real-time by the artificial intelligence models of the computerized system, the aerial information with respect to another ground vehicle of the one or more different ground vehicles, to provide another driving decision for the other ground vehicle for autonomous driving; and
communicating, in real-time, the other driving related decision to a computerized system associated with the other ground vehicle.

7. The method of claim 1, wherein the processing involves detection of road objects within the identified field of view.

8. The method of claim 7, wherein the detection of road objects is based on computation of kinematics that are processed from the aerial information.

9. The method of claim 1, wherein the processing involves identifying a data layer comprising road objects within the identified view.

10. The method of claim 1, wherein the processing involves path planning for the specified ground vehicle.

11. The method of claim 1, wherein the processing involves determining a localization of the specified ground vehicle.

12. A non-transitory computer readable medium of artificial intelligence models for continuous real time autonomous driving of ground vehicles that stores instructions that, when executable by at least one processing device, cause the device to:
obtain, during inference by a computerized system associated with an aerial system, aerial information captured by the aerial system at a period of time and a location corresponding to a driving of one or more different ground vehicles, wherein the aerial system is associated with computerized systems of the one or more different ground vehicles;
process, in real-time by artificial intelligence models of the computerized system, the aerial information with respect to a specified ground vehicle of the one or more different ground vehicles, to provide a driving related decision for the specified ground vehicle for autonomous driving; and
communicate, in real-time, the driving related decision to a computerized system associated with the specified ground vehicle, for continuous real time driving of the specified ground vehicle from air.

13. The non-transitory computer readable medium of claim 12, wherein the aerial information is captured by the aerial system using an artificial intelligence model trained based on aerial information units for use in driving.

14. The non-transitory computer readable medium of claim 12, further storing instructions that when executable by the at least one processing device cause the device to process the aerial information in accordance with an identified environment that covers a field of view that is greater than a field of view of ground sensors associated with the specified ground vehicle.

15. The non-transitory computer readable medium of claim 12, further storing instructions that when executable by the at least one processing device cause the device to communicate the driving related decision to the computerized system by interfacing with an autonomous driving system of the specified ground vehicle.

16. The non-transitory computer readable medium of claim 12, further storing instructions that when executable by the at least one processing device cause the device to communicate the driving related decision to the computerized system by interacting with a teleoperation control system that is external to the specified ground vehicle and in communication with the specified ground vehicle.

17. The non-transitory computer readable medium of claim 12, further storing instructions that when executable by the at least one processing device cause the device to:
process, in real-time by the artificial intelligence models of the computerized system, the aerial information with respect to another ground vehicle of the one or more different ground vehicles, to provide another driving decision for the other ground vehicle for autonomous driving; and
communicate, in real time, the other driving related decision to a computerized system associated with the other ground vehicle.

18. (canceled)

19. (canceled)

20. The non-transitory computer readable medium of claim 12, further storing instructions that, when executable by at least one processing device, cause the device to:
incorporate the driving related decision in an autonomous driving decision making of the specified ground vehicle.

21. A system for continuous real time driving, comprising:
a memory configured to store aerial information of a region containing one or more different ground vehicles and captured by an aerial system, wherein the aerial system is associated with computerized systems of one or more different ground vehicles; and
a processor configured to:
obtain, during inference by a computerized system associated with the aerial system, the aerial information captured by the aerial system at a period of time and a location corresponding to a driving of the one or more different ground vehicles;
process, in real-time by artificial intelligence models of the computerized system, the aerial information with respect to a specified ground vehicle of the one or more different ground vehicles, to provide a driving related decision for the specified ground vehicle for autonomous driving; and
communicate, in real-time, the driving related decision to a computerized system associated with the specified ground vehicle, for continuous real time driving of the specified ground vehicle from air.
